(19) United States
(12) Patent Application Publication
(10) Pub. No.: US 2019/0202058 A1
(43) Pub. Date: Jul. 4, 2019

(54) METHOD OF PROGRAMMING AN INDUSTRIAL ROBOT

(71) Applicant: ABB SCHWEIZ AG, Baden (CH)

(72) Inventors: Fan DAI, Zwingenberg (DE); Antonio SCHILIRO, Heidelberg (DE)

(21) Appl. No.: 16/297,874

(22) Filed: Mar. 11, 2019

Related U.S. Application Data
(63) Continuation of application No. PCT/EP2017/066286, filed on Jun. 30, 2017.

(30) Foreign Application Priority Data
Sep. 13, 2016 (EP) 16188527.2

(51) Int. Cl. B25J 9/16; B25J 13/06

(52) U.S. Cl. CPC B25J 9/1671; B25J 9/1697; G05B 2219/39001; G05B 2219/40099; G05B 2219/40392; B25J 13/06

(57) ABSTRACT

A method of programming an industrial robot having a robot arm with an end-effector mounted thereto, which is controlled by a robot control unit to manipulate a workpiece which is arranged in a workplace of the robot, a target coordinate system being associated with the workplace and an image of the workplace and the workpiece is taken by an image capturing device and transmitted to a computing device having a human-machine-interface to generate control code for controlling the robot which is transmitted to the robot control unit, includes the following steps: capturing an image of the workplace and the workpiece to be manipulated by the robot; transferring the captured image to the computing device; displaying the captured image on a display associated to the computing device; marking the workpiece displayed on the display with a marker-object on the display; manipulating the marker-object in a sequence.

### CROSS-REFERENCE TO PRIOR APPLICATION

This application is a continuation of International Patent Application No. PCT/EP2017/066286, filed on Jun. 30, 2017, which claims priority to European Patent Application No. EP 16188527.2, filed on Sep. 13, 2016. The entire disclosures of both applications are hereby incorporated by reference herein.

### FIELD

The invention is related to a method of programming an industrial robot.

### BACKGROUND

Industrial robots are automated machines which can be programmed to perform different manipulation tasks incorporating spatial motion of their end-effectors like grippers or welding tools etc. Traditionally, industrial robots are programmed in procedural programming languages with motion control functions, typically with position and velocity as input parameters. This requires knowledge and skills about the programming language and the usage of the functions. In addition, the definition of appropriate and accurate position data and velocity profiles of the robot can be difficult and time consuming.

Commercial industrial robots are commonly supplied with a teach pendant by means of which an operator can “jog” the robot to move to a desired position and take this as an input parameter for the motion functions. Although this technique reduces the amount of manual data input, the jogging of the robot requires a lot of skill and experience and can be still time consuming.

Another technique that is being used for programming some robots is the so-called “lead-through” where the robot is taken by hand and follows the movement of the human hand. This can only be applied to robots that fulfill corresponding safety requirements and support such a mode of operation.

“Programming by demonstration” is a further technique by which human actions are tracked and interpreted to obtain robot instructions. One problem involved in this technique is that human gestures are interpreted with insufficient reliability and the desired parameters for controlling the robot motion cannot be obtained with the necessary accuracy. Moreover, it is a further shortcoming of this method that during demonstration of an assembly of small components, these components are often obstructed from view by the human hands themselves.

Object-oriented techniques using vision-based object localization require in general also the programing of appropriate vision jobs that is even more difficult to learn and to perform by application engineers.

### SUMMARY

In an embodiment, the present invention provides a method of programming an industrial robot having a robot arm with an end-effector mounted thereto, which is controlled by a robot control unit to manipulate a workpiece which is arranged in a workplace of the robot, wherein a target coordinate system is associated with the workplace and an image of the workplace and the workpiece is taken by an image capturing device and transmitted to a computing device having a human-machine-interface to generate control code for controlling the robot which is transmitted to the robot control unit, the method comprising: capturing an image of the workplace and the workpiece to be manipulated by the robot; transferring the captured image to the computing device; displaying the captured image on a display associated to the computing device; marking the workpiece displayed on the display with a marker-object on the display; manipulating the marker-object in a sequence of at least two subsequent manipulating steps which are associated to robot commands on the display by the human-machine-interface, the sequence of manipulating steps including positions of the marker-object in a coordinate system for displaying the marker-object on the display; transforming the positions of the marker-object in the sequence of manipulating steps to positions of the workpiece in the target coordinate system; and generating control code from the transformed positions and associated robot commands for controlling the robot.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic overview of a robot and a workplace with a workpiece in the form of a fuse which has to be inserted into a rail, together with a computing device, a camera, a display and a robot controller for carrying out the method according to the present invention,

FIG. 2 is a schematic view of the display connected to a computing device of FIG. 1 on which a software program is executed having a graphical user interface with control buttons for programming the robot after capturing the image of the workplace of FIG. 1,

FIG. 3 shows the display with the graphical user interface when marking the image of the captured fuse with a marker-object in the form of a rectangular frame,

FIG. 4 shows the display with the graphical user interface after activating a control button for grasping the workpiece,

FIG. 5 shows the display with the graphical user interface after activating a control button for moving the marker-object with a copy image to the new position in the captured image shown on the display,

FIG. 6 shows the display with the graphical user interface after activating a control button for rotating the marker-object,

FIG. 7 shows the display with the graphical user interface after activating a control button for moving the robot tool downward to snap the workpiece (fuse) into the rail, and

FIG. 8 shows the display with the graphical user interface after activating a control button for generating the control code including the sequence of manipulating steps which is transformed into a transformed sequence of manipulating steps in the target coordinate system of the workplace shown in FIG. 1.

### DETAILED DESCRIPTION

Accordingly, it is a problem of the present invention to provide a method of programming an industrial robot more easily.

Nowadays, people are used to work with computing devices like personal computers, tablet computers or smart phones, which provide a human-machine-interface and a graphical user Interface (GUI) which allow to mark, rotate, resize, or move graphics elements on the display of the computing device. Accordingly, it is quite easy to display and manipulate camera images with the known computing devices, so that direct manipulation of graphics and images has become an intuitive way of user-computer interaction in general. As the applicant of the subject application has found, such a computing device can be used to define spatial motion and key positions for manipulating a workpiece in an intuitive way when displaying an image of the robot workplace on the display connected or included in such a device, like e.g. a computer display or a touchscreen of a tablet computer.

According to the invention, the method of programming a robot comprises the following general steps:

taking a digital picture of the workplace of the robot and the workpiece to be manipulated with a camera,

transferring the image to the computing device on which a software program is executed which at the same time displays the image and provides control buttons which are associated to tasks (control-actions) of the robot like moving arm, rotating arm, rotating tool, opening gripper, closing gripper or activating welding tool etc. depending of the kind of robot and tool (end-effector) used,

Selecting the workpiece by marking the workpiece graphically with a marker-object, preferably a rectangular frame, on the image.

Selecting one of the robot tasks via the control buttons or other input channels like graphic menu or speech (HMI).

Move or position the marker object or a cropped image of the workpiece displayed on the display screen to define key or target positions.

Use additional graphic elements to specify other parameters like grasp position, motion direction, etc.

Use other input channels to enrich task parameterization, when necessary

Storing each key position together with the robot task as a sequence of manipulating steps including key positions and associated robot tasks,

Transforming the sequence of manipulation steps from the coordinate system used by the computing device for displaying the captured image on the display screen to the target coordinate system of the workplace and generate control code for controlling the robot from this transformed sequence.

This method can be applied to the majority of robot applications, when the workplace of the robot is approachable from one side. In fact, most of the pick & place and assembly applications have one or two workplaces of the robot, which are approached from the top or front side. The input method can be implemented so that people who are used to deal with smart phones and tablet computers can use bare hand, pen or mouse and keyboard on his/her convenience.

It is an advantage of the invention that the programming method can be implemented such that people used to deal with smart phones and tablet computers can use their hand, a pen or a computer mouse and keyboard on his/her convenience to carry out the programming.

The method uses a real image of the scene with the objects to be manipulated which is captured with an image capturing device like a camera and provided as a digital image, so that the user can specify object-related position and motion parameters directly in the image of the scene which is displayed on a display attached to the computing device which is preferably a personal computer or even more preferably a hand held device like a tablet computer or PDA with a touchscreen, on which a software program is executed which will be described hereinafter in more detail.

It is a further advantage of the present invention that no image processing or feature recognition is necessary, in order to recognize and identify the object to be manipulated which tremendously reduces the hardware requirements and amount of data to be processed. Moreover, there is also no specific requirement for illuminating the workplace and object to be manipulated with a special light source in order to provide for a contrast which is sufficient to clearly recognize and capture an image of the object which can be used for further automated data processing.

Although the method according to the invention does not require any image processing or feature recognition, there is also the possibility that for robot systems using integrated vision sensors, the image-based input results, e.g. the marked area and the key positions, could be also fed to the vision system to automatically generate vision jobs and/or significantly reduce the effort of vision programming.

An additional benefit of the invention is that the programming can be done independently from a robot, assuming that reachability can be handled as a separate problem with known methods.

For carrying out the above-described method, the system only requires the following components:

a) A computing device with a display and input means, like e.g. a personal computer or a tablet computer or a smartphone
b) A camera, which can also be integrated with the computing device or the robot.
c) A robot controller
d) A software module running on the computing device which preferably provides a graphical user interface (GUI) for displaying the control buttons and captured image etc.

The camera is placed above or in front of the desired workplace of an industrial robot and is able to capture an image of the working place with the workpiece to be manipulated by the robot. The camera image is transferred to the computing device or stored at a place accessible from the computing device. The image is shown on the display. The user is able to use input means like a computer mouse, touch screen, keyboard or pen, etc., which are hereinafter called a human-machine-interface (HMI), to select a robot function for object manipulation, place a graphic symbol to a position on the image, manipulate (move, resize, rotate) the marker-object (symbol which marks the workpiece to be manipulated by the robot), or just mark a pose.

Optionally, the graphical user interface may provide additional graphic means related to the marker-object to obtain additional information like grasping position, intended orientation of motion, etc.

As a further option, other input methods like menus, forms, etc. can be used to enter additional data like the type of objects, desired velocity of the workpiece, gripping force, etc.; and the image portion marked by the symbol (typically the image of the workpiece, which is hereinafter also referred to as the object to be manipulated, is copied and overlaid onto the marker object and can be moved together with the marker-object for more intuitive definition of the manipulation-actions and key positions associated therewith. As a further option, it is also conceivable to replace the marker-object by an own predefined preferably colored symbol, the size and shape of which may be changeable by the operator.

In order to generate the control code to be sent to the robot control, the original and target image position of the marker-object (symbol) are converted to real world coordinates in the workplace of the robot manipulator and are preferably interpreted as parameters for the robot function by the software module on the computing device.

In this respect, known methods for image calibration and coordinate system transformations can may used to perform the conversion of the data.

For robot applications which do not require a very accurate calibration of the robot and tool mounted to the robot (which is hereinafter generally referred to as an end-effector) it may alternatively be possible that the user simply clicks on a few positions or marks the positions in the captured image and enters the image-to-real-world scaling factor manually.

These parameters together with the key positions and associated robot actions which are hereinafter referred to as a transformed sequence of manipulating steps are then fed to the robot controller. Optionally, a robot program containing the corresponding robot instructions with these parameters may be generated and/or stored and fed to the robot controller when the robot is used.

The robot controller drives the robot manipulator accordingly to perform the robot function in the real workplace (real scene).

Optionally a virtual controller may be used to simulate the task, and the data related to the symbols like size, position, or even the marked image portions can be used for the parameterization of a vision job, with which the part can be recognized and localized at runtime. The aforementioned parameters for the robot function can be adapted to the actual position of the workpiece(s) or other elements which are located in the worksplace.

According to a further embodiment of the invention, and as mentioned partly before, the graphical user interface (GUI) may provide buttons by means which the marker-object (graphic symbol) can be resized to cover different object sizes or rotated to cover different object orientations. Moreover, there may be buttons by which the marker-object may be provided with graphic means which indicate the gripping position and/or graphic means which indicate the desired motion direction and/or graphic means which indicate the local coordinate system of the corresponding object to be manipulated or the robot tool (e.g. gripper) or the desired pose for the robot function.

This additional information can be interpreted and used as a parameter of the corresponding robot function.

While using a 2D image and 2D input methods, the applicability of this system is limited to tasks that do not require 3D information, unless additional information is provided to cover the third dimension, e.g. a reference height of the object or of the robot tool. This can be done with other input methods like mentioned before.

According to a further object of the invention, this limitation can also be overcome, if the robot system has the capability (skills) to automatically deal with uncertainties at least in the third dimension, e.g. via distance or contact sensing.

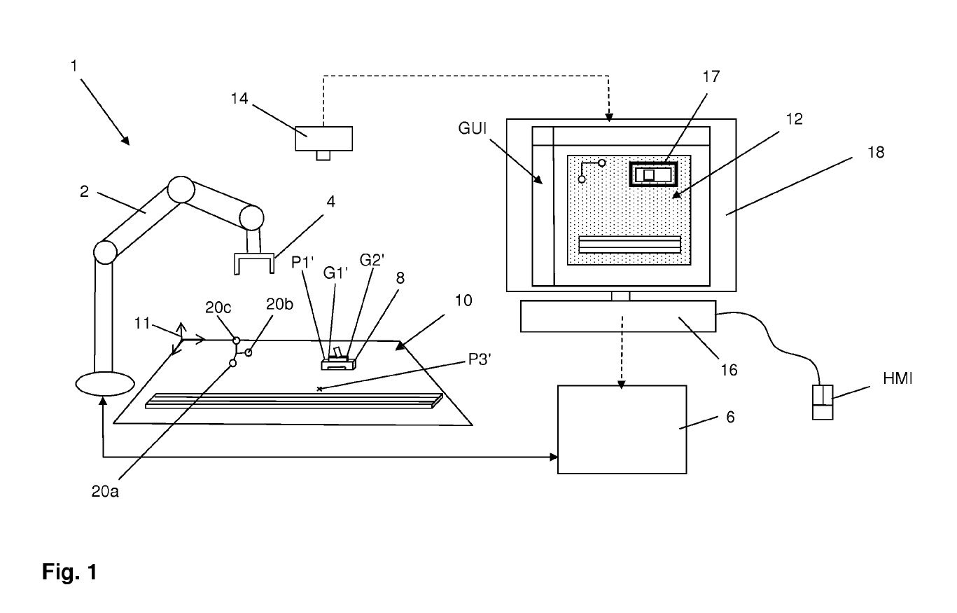

As it is shown in FIG. 1, an industrial robot 1 having a robot arm 2 with an end-effector in form of a gripper 4 is controlled by a robot control unit 6, in order to manipulate a workpiece 8 which is arranged in the workplace 10 of the robot 1. In the workplace 10, the movement of the robot/end-effector 4 is controlled in a target coordinate 11 system associated to said workplace 10. Above the workplace 10 there is located an image capturing device in form of a camera 14 which is used to take a digital image 12 of said workplace 10 with said workpiece 8 located therein. The captured image 12 is transmitted to a computing device 16 which is connected to a display 18 and which is operated by means of a human-machine-interface HMI in form of the shown computer mouse pointing device and a graphical user interface GUI for operating the program and inputting data.

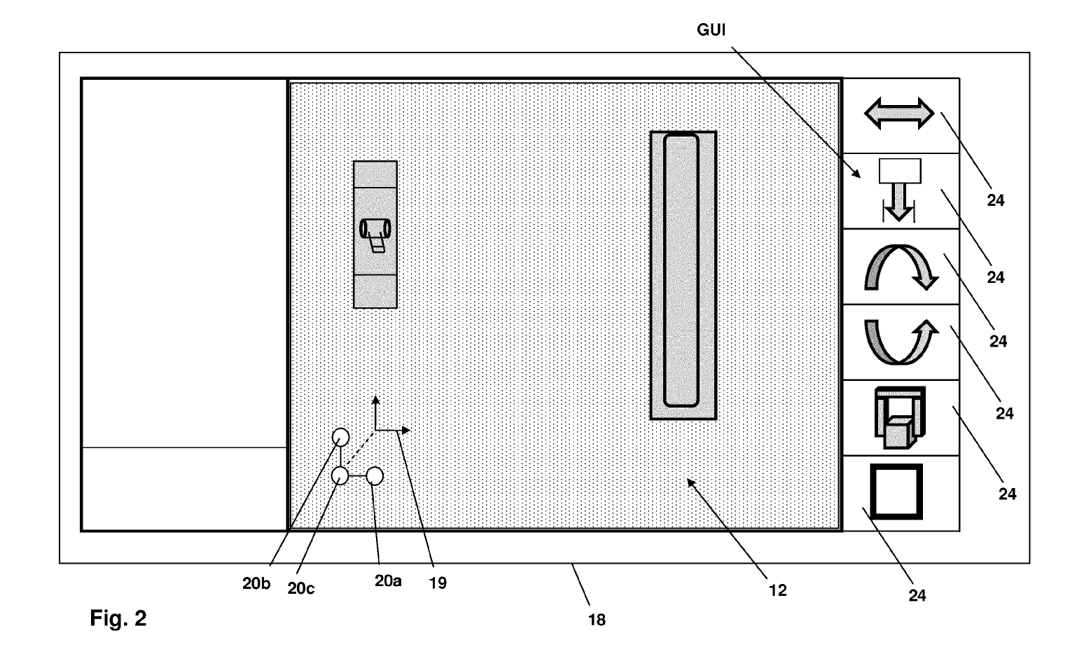

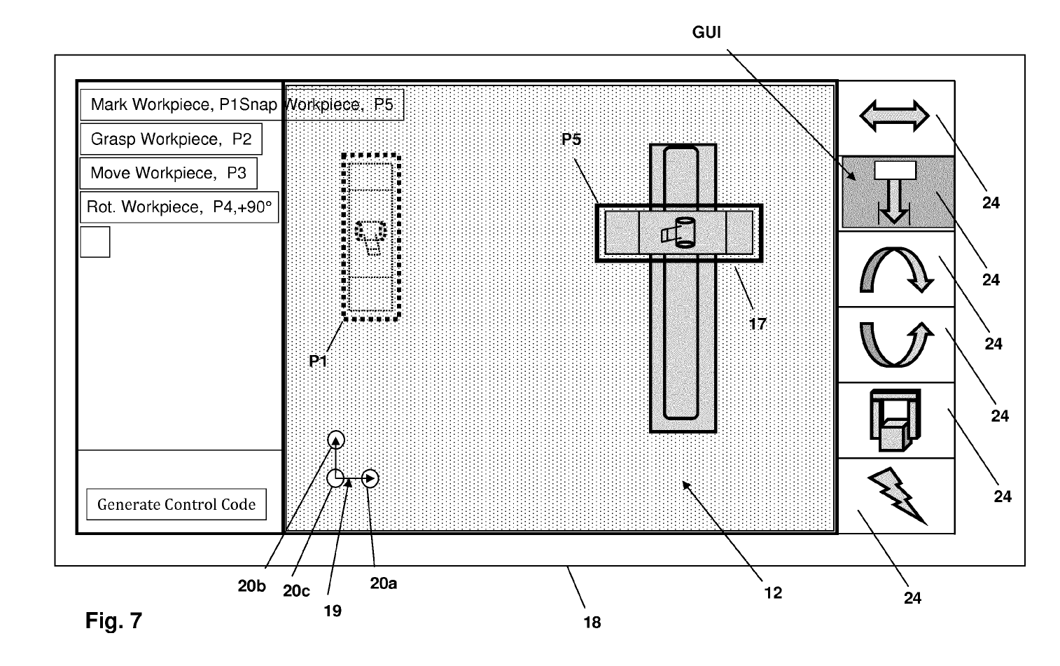

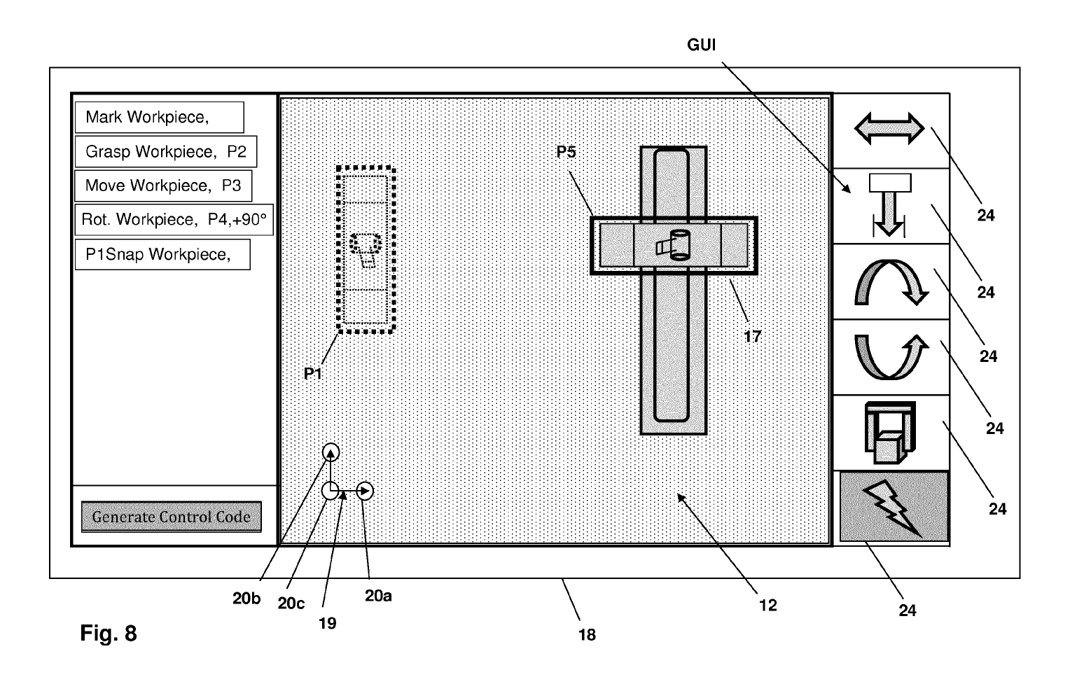

The computing device 16 executes a software program which generates control code that is transmitted to the robot control unit 6 as it will be described hereinafter with reference to FIGS. 2 to 8.

For programming the robot 1, the image 12 of the workplace 10 and the workpiece 8 is captured by means of the camera 14 and preferably directly loaded to the computing device 6 and displayed as a captured digital image on the display 18 connected to the computing device 16, as it is shown in FIG. 2.

As a next step, the operator visually identifies and marks the workpiece, or more precisely the area of the image 12 which corresponds to the workpiece 10, in the image 12 on the display 18 with a marker—object 17 that is provided by a software program that generates a graphical user interface GUI on the display 18.

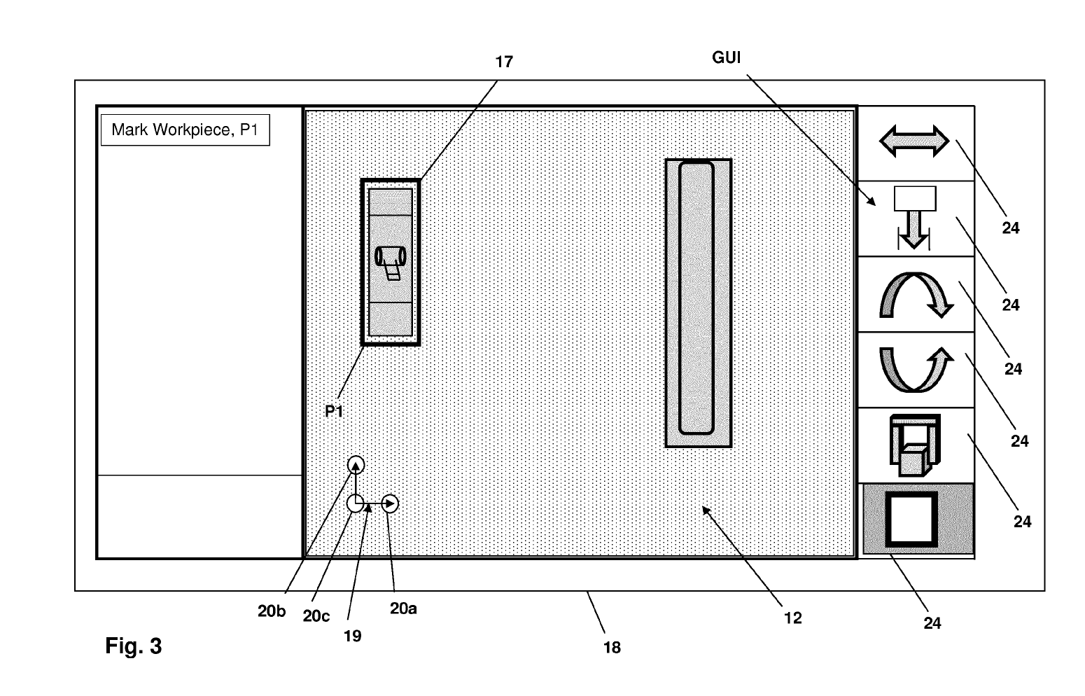

As it is shown in FIG. 3, the marker-object is preferably a rectangular frame 17, the size and/or position of which can be changed by means of the human-machine-interface HMI, as it is commonly known from image processing software programs running on personal computers, tablets or even mobile phones, for manipulating digital images.

After marking the image portion representing the workpiece 8 displayed on the display 18 with the rectangular frame 17, the image area inside the rectangular frame 17 is copied and joined to the rectangular frame 17 so that the copied image area is moved together with the frame 17 when moving the frame in the captured image in further programming steps. In order to allow a precise positioning of the marked object 17 the copied image area is preferably displayed on the captured image 12 as a transparent image area, so that the operator can recognize other objects which are located in the workspace and displayed in the digital image 12 on the screen 18, in order to exactly move the frame to a desired position.

As a next step, the marker-object 17 is moved and manipulated on the display in a sequence of at least two subsequent manipulating steps by means of said human-machine-interface (HMI). In each manipulating step, the position P1 to P5 of the marker-object 17 in a coordinate system 19 associated to the display 18 is recorded together with a command that is associated to a robot action.

In the preferred embodiment of the invention, the robot action can be selected by activating a control button 24 with the human-machine-interface HMI which is generated on the display next to the image 12. The activation of the control button 24 for a desired robot command, like “position gripper bars of end-effector”, “grasp workpiece with end-effector”, “move end-effector”, “rotate end-effector” or “snap workpiece to other object” etc. adds the actual position P1 to P5 of the marker-object 17 and/or the grasping position G1, G2 of the gripper bars 22a, 22b of an end-effector preferably together with a command which is associated to a desired action of the robot to a sequence of at least two subsequent manipulating steps.

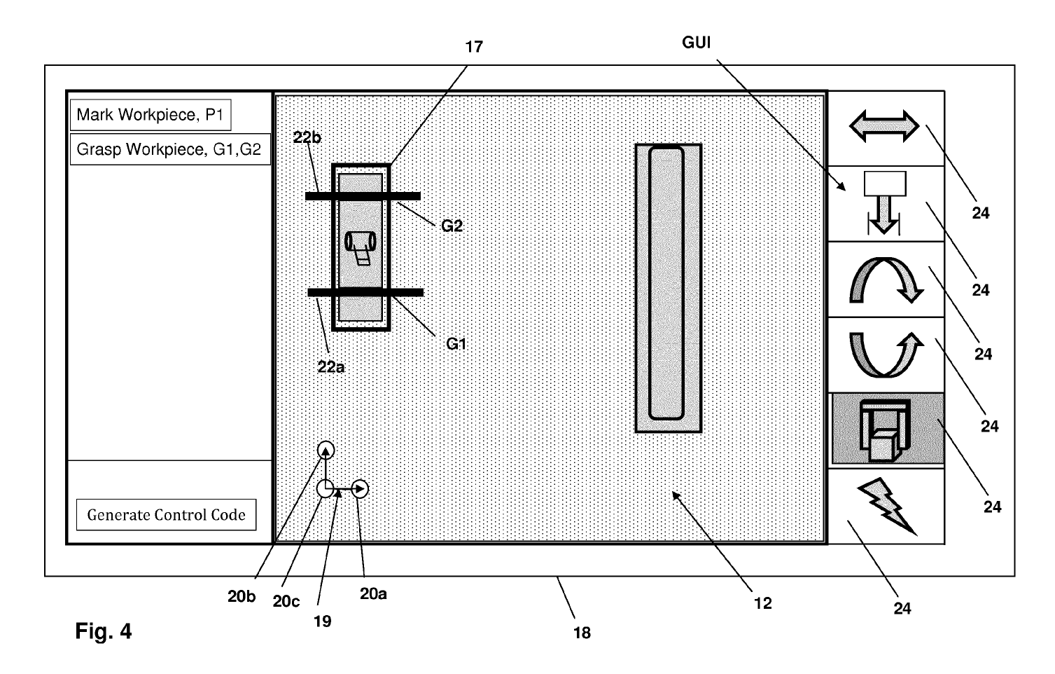

In a further preferred embodiment, sequence of manipulating steps can also include the step of providing two parallel bars 22a, 22b on said display 18, as it is shown in FIG. 4 which can be positioned near the marker-object 17 by means of the human-machine-interface HMI and rotated in a position such that the bars 22a, 22b are aligned to the sides of the marker object 17. Afterwards, the parallel bars can be moved towards and away from each other in order to define a grasping position G1, G2 of the gripper bars 22a, 22b (of said end-effector), in which the workpiece 8 is grasped by said robot 1. The grasping positions G1 and G2 are also stored in the sequence of manipulating steps and transformed to the target coordinate system 11 of the workplace (robot) as described herein below.

After the marker-object 17 has been placed in the desired final position and the manipulation of the marker-object 17 on the display 18 has been completed, the positions P1 to P5 of the marker-object in the coordinate system 19 of the display 18 are preferably stored together with the associated commands and are afterwards transformed to positions P1′ to P5′ which correspond to the workpiece 8 in the target coordinate system 11 of the workplace 10, as it is indicated in the drawing of FIG. 1.

In the preferred embodiment of the invention, the transformed Positions P1′ to P5′ of the manipulating steps are stored together with the commands as a transformed sequence of manipulating steps from which either the computing device 16 or the robot control unit 6 generates the final control code for controlling the robot 1, to move the workpiece 8 in the workplace 10 to the desired final position P5′.

According to a further aspect of the present invention, the positions P1 to P5 of the marker-object 17 in the sequence of manipulating steps may be stored together with the associated manipulation command or robot commands in a data set. This data set may be transformed by a known transformation method to a further data set which includes the transformed positions P1′ to P5′ of the workpiece 8 in the target coordinate system 11 of the workpiece 10. However, this coordinate system 11 can be different from the internal coordinate system of the robot 1, so that a further known transformation of the further data sets might be necessary, which shall be included in the transformation of the position data P1 to P5 in the sequence of manipulation steps as described in this application.

According to another aspect of the present invention, at least two reference points 20a, 20b, 20c may be located on said workplace 10 before capturing said image 12, as it is shown in FIG. 1. The reference points 20a, 20b, 20c may be markers or the ball shaped end portions of a tripod shown in FIG. 1 which define a fixed reference position for the robot 1 in the target coordinate system 11 of said workplace 10. In order to calibrate this reference position, the operator can manually jog the end-effector 4 of the robot 1 to this reference points 20 and store the position in the robot control unit 6.

After loading the digital image 12 of the workplace 10 showing the reference points 20 into the computing device 6, the operator identifies the image portion of the reference points 20a, 20b, 20c in the captured image 12 by means of the human machine interface HMI, e.g. by clicking on the points 20 with a mouse pointer. The position data of each reference point 20a to 20c is stored in the computing device 6 and matched to the position data of the ball shaped end portions of the tripod taken by the robot 1 as described herein before. Alternatively, it is also conceivable to permanently attach the reference points 20 to a fixed position which is known to the robot control unit 6. From the position data of the reference points 20a, 20b, 20c in the target coordinate system 11 which are stored in the robot control unit 6 and the identified corresponding image portions of the reference points in the captured image 12 a scaling factor and/or an angular offset between the coordinate system 19 associated to the displayed image 12 and the target coordinate system 11 can be calculated.

As an alternative method of matching the coordinate system 24 associated to the displayed image 12 and the target coordinate system 11, the captured image 12 on the display 18 may be rotated on the display and/or expanded in vertical and horizontal direction of the display, until the length and orientation of the arrows indicating the coordinate system 19 matches the length and orientation of the corresponding portions of the tripod, as it is indicated in FIG. 2 and FIG. 3. This embodiment of the method allows a very simple programming of a robot 1 when using a computing device 16 in the form of a handheld device which has an integrated camera 14, because the transformation of the position data in the sequence of manipulating steps can be done by multiplying the horizontal and vertical position of a key position in which a manipulation of the marker-object 17 is done with the respective scaling factors.

In order to increase the precision of the programming, the handheld device or the camera 14 may be mounted to a supporting frame located above said workplace 10 for capturing said captured image in a plane which is parallel to a plane of the workplace 10.

A typical workflow with the system is now being described hereinafter with reference to an exemplary embodiment of the method shown in FIGS. 2 to 8.

After capturing and downloading the image 12 of the workplace 10 with the reference points 20a, 20b, 20c and workpiece 8 to be manipulated into the computing device 16, the operator rotates and expands the image 12 such that the shown arrows which represent the coordinate system 19 associated to the display 18 superpose the images of the reference points 20a and 20b, as it is shown in FIGS. 3 to 8.

In a next step, the operator activates the control button 24 (highlighted) which generates the marker-object 17 which the operator moves and resizes to the rectangular frame until it surrounds the image portion of the workpiece in the image 12. The position P1 of the frame is stored as an initial key position of the frame in the sequence of manipulating steps in the control device.

As further shown in FIG. 4, the operator then activates a control button 24 (highlighted) which is associated to positioning and grasping the workpiece 8 by means of a gripper 4 which is shown as an end-effector or tool of the robot 1 in FIG. 1. By rotating and moving the two bars 22a and 22b the bars are located in the desired grasping positions G1, G2 of the gripper 4 in the image 12 which are also stored in the sequence of manipulating steps.

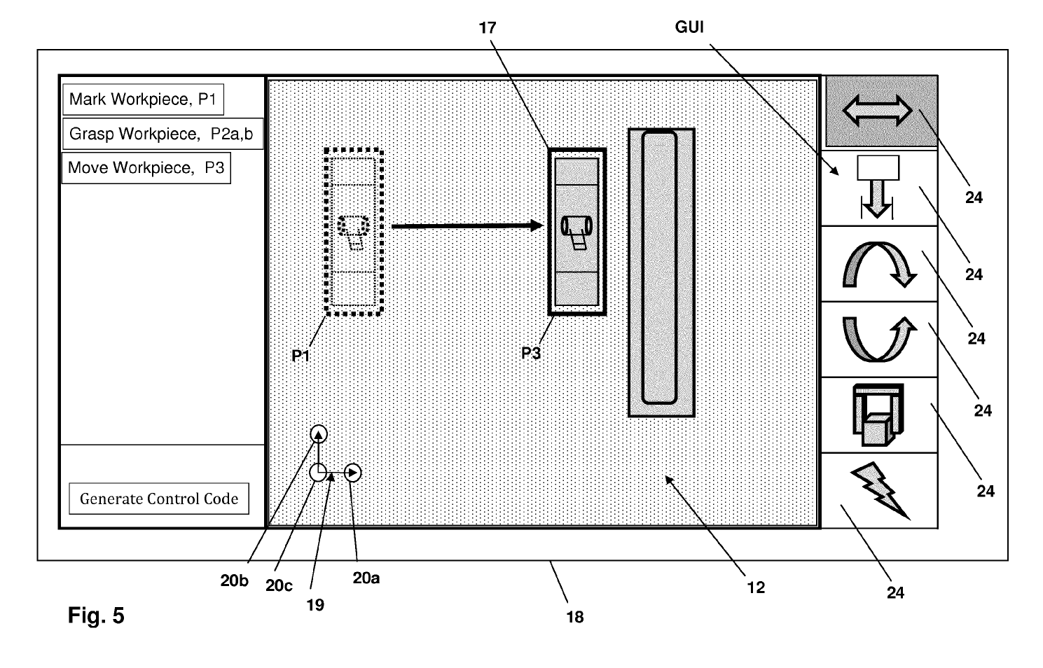

In a next step (FIG. 5), the operator activates the control button 24 which is related to lifting and moving the workpiece 8, or to be precise, the gripper 4 attached to the robot arm 2. By clicking on the frame 17 and pulling the same in a way as it is known from prior art image processing programs, the frame is positioned at the desired position which is saved together with the associated robot command as position P3 in the sequence of manipulating steps.

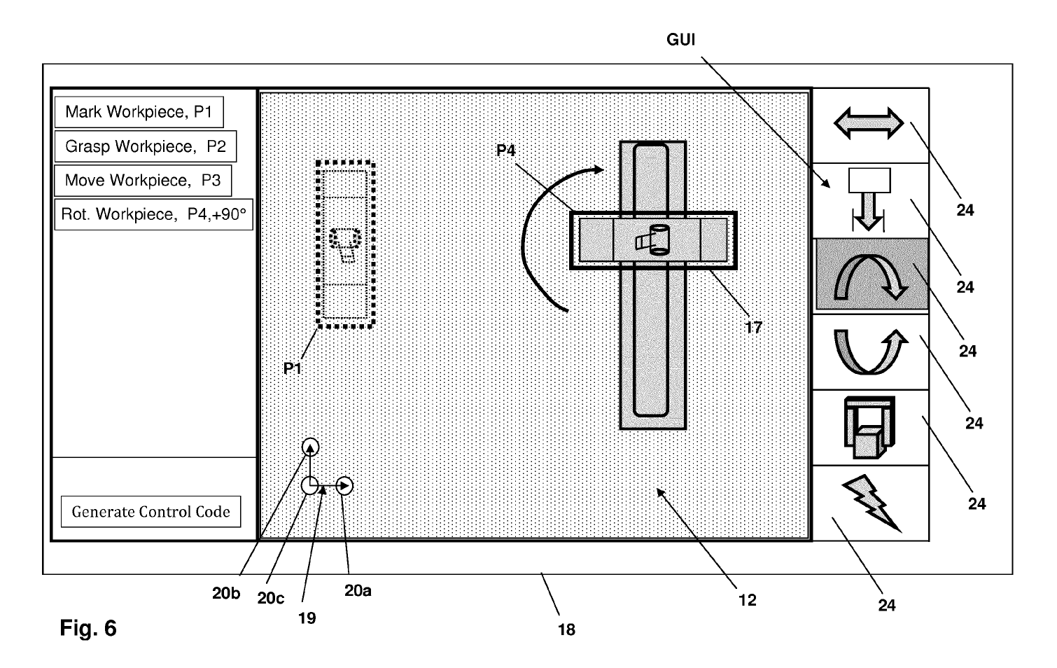

In a subsequent step which is illustrated in FIG. 6, the operator activates a control button 24 which is related to a robot command which rotates the gripper/end-effector 4 clockwise as indicated by the arrow. The angle of rotation, which might also be inputted to the computing device by means of a keyboard is saved together with the new position P4 of the frame 17 to the sequence of manipulating steps.

In a last manipulating step, the operator activates a control button 24 which is related to a robot command which lowers the gripper and presses the workpiece into the rail where the frame 17 (or to be precise the lower left edge of the frame) is lowered to a final position P5 in which the workpiece 12 snaps into the rail positioned in the workplace 10. The robot 1 may be equipped with a sensor and close loop control which autonomously moves the gripper 4 or the robot 1 to the exact position relative to the rail in which the workpiece (fuse) 8 snaps into a recess provided in the rail.

After this step, the operator can activate a button which activates the computing device 16 to transform position data P1 to P5 and G1, G2 in the sequence of manipulating steps to coordinates P1′ to P5′ in the target coordinate system 11 and generate the control code for the robot 1. The control code may be transferred to the robot control unit 6 automatically.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LISTING OF REFERENCE NUMERALS

1 robot
2 robot arm
4 end-effector (tool)
6 robot control unit
8 workpiece
10 workplace of robot
11 target coordinate system
12 captured image
14 capturing device/camera)
16 connecting lines/arrows
17 marker-object
18 display
19 coordinate system of display
20a reference point
20b reference point
20c reference point
22a bar
22b bar
24 control button
GUI graphical user interface
HMI human-machine-interface
G1, 2 grasping position
P1-P5 positions of marker-object
P1′-P5′ transformed positions

What is claimed is:

1. A method of programming an industrial robot having a robot arm with an end-effector mounted thereto, which is controlled by a robot control unit to manipulate a workpiece which is arranged in a workplace of the robot, wherein a target coordinate system is associated with the workplace and an image of the workplace and the workpiece is taken by an image capturing device and transmitted to a computing device having a human-machine-interface to generate control code for controlling the robot which is transmitted to the robot control unit, the method comprising:
capturing an image of the workplace and the workpiece to be manipulated by the robot;
transferring the captured image to the computing device;
displaying the captured image on a display associated to the computing device;
marking the workpiece displayed on the display with a marker-object on the display;
manipulating the marker-object in a sequence of at least two subsequent manipulating steps which are associated to robot commands on the display by the human-machine-interface, the sequence of manipulating steps including positions of the marker-object in a coordinate system for displaying the marker-object on the display;
transforming the positions of the marker-object in the sequence of manipulating steps to positions of the workpiece in the target coordinate system; and
generating control code from the transformed positions and associated robot commands for controlling the robot.

2. The method of claim 1, wherein the positions of the marker-object in the sequence of manipulating steps are stored together with the associated robot commands in a data set, and/or the transformed positions of the workpiece in the target coordinate system are stored together with the associated robot commands as in a further data set.

3. The method of claim 1, wherein the computing device provides a graphical user interface on the display, the graphical user interface having control buttons that are activatable by the human-machine-interface, and
wherein an activation of a control button generates a manipulating step associated with a robot command in the sequence of manipulation steps.

4. The method of claim 3, wherein the control buttons are displayed on the display together with the captured image of the workplace.

5. The method of claim 1, wherein the sequence of manipulating steps includes generating the marker-object on the display and/or position gripper bars of the end-effector and/or grasping a workpiece with the end-effector, and/or moving the end-effector, and/or rotating the end-effector and/or open gripper bars of end-effector.

6. The method of claim 1, wherein the sequence of manipulating steps includes:
providing two parallel bars on the display;
moving the two parallel bars to the marker-object by the human-machine-interface;
rotating the parallel bars; and
moving the parallel bars towards and away from each other in order to define a grasping position of the gripper bars of the end-effector, in which the workpiece is grasped by the robot.

7. The method of claim 1, wherein the marker-object comprises a rectangular frame which is configured to be positioned and/or moved and/or resized and/or rotated on the display by the human machine interface.

8. The method of claim 7, wherein, after marking the workpiece displayed on the display with the rectangular frame, an image area inside the rectangular frame is copied and joined to the rectangular frame such that when moving the rectangular frame on the display by the human-machine-interface, the copied image area is moved together with the rectangular frame in the captured image.

9. The method of claim 8, wherein the copied image area is displayed on the captured image as a transparent image area.

10. The method of claim 1, further comprising:
arranging at least two reference points on the workplace before capturing the image, the reference points defining a fixed reference position for the robot in the target coordinate system of the workplace;
identifying the reference points within the captured image by the human machine interface; and
calculating a scaling factor and/or an angular offset between the captured image relative to the target coordinate system by the identified reference points in the captured image.

11. The method of claim 1, wherein the computing device comprises a handheld device with an image capturing device comprising an integrated camera,
wherein the human-machine-interface comprises a touchscreen, and
wherein the captured image of the workspace and the workpiece is captured by the camera and displayed on the touchscreen together with the control buttons of the graphical user interface.

12. The method of claim 11, wherein the handheld device is mounted to a supporting frame located above the workplace for capturing the captured image.
